(19) United States
(12) Patent Application Publication
(10) Pub. No.: US 2015/0044978 A1
(43) Pub. Date: Feb. 12, 2015

(54) WIRELESS COMMUNICATION SYSTEM HAVING A PLURALITY OF MULTIPLEXED RECEIVERS

(71) Applicant: RENAULT s.a.s., Boulogne-billancourt (FR)

(72) Inventors: Andres Bohorquez Prieto, Grenoble (FR); Sylvain Bacquet, Chasselay (FR)

(73) Assignee: RENAULT s.a.s., Boulogne-billancourt (FR)

(21) Appl. No.: 14/384,934

(22) PCT Filed: Mar. 12, 2013
(86) PCT No.: PCT/FR2013/050515

§ 371 Date: Sep. 12, 2014

(30) Foreign Application Priority Data
Mar. 13, 2012 (FR) 1252224

(51) Int. Cl. H04B 1/38; H04B 1/40

(52) U.S. Cl. CPC H04B 1/3822; H04B 1/40
USPC 455/90.1

(57) ABSTRACT

A wireless communication system for a motor vehicle including a removable battery, the system including a transmitter which is to be rigidly connected to the vehicle and which is configured to be connected to an electronic control unit of the vehicle, and at least one receiver which is to be rigidly connected to the removable battery and which is to be connected to at least one sensor for measuring a parameter of the removable battery, the transmitter and the at least one receiver configured to exchange data via an inductive coupling.

The invention lies in the technical field of contactless communications, more particularly contactless communications in a metal environment.

It is known to use a transmitter for providing an electromagnetic field in order to supply power to receivers by inductive coupling. It is thus possible to transfer energy effectively between a single source and a plurality of elements to be charged. One application is the recharging of multi-cell batteries.

However, regardless of the method of energy transfer, recharging a battery, to be effective, requires measurements, such as the voltage at the terminals of the battery, its temperature and the current flowing between its terminals.

In order not to hinder the setting up of effective contactless charging, it is also necessary to transmit the contactless measured values.

The document DE102009035472 provides an apparatus for reading the charge state of batteries in an electric vehicle, consisting of a transponder placed on the battery for the wireless transmission of the measured charge state value.

The document U.S. Pat. No. 7,911,182 describes a method and corresponding apparatus for detecting a battery voltage. This document essentially discloses a method of implementation.

Other patents also provide recharging systems for batteries, this is the case of documents EP2048764 and U.S. Pat. No. 7,692,404.

One object of the invention is therefore to contactlessly communicate the measurements of various magnitudes in a metal environment.

Another object of the invention is to provide an optimal method of setting the transmission power.

Another object is to provide a multiplexed transfer of measurements.

A wireless communication system is provided for a motor vehicle provided with a removable battery, including a transmitter intended to be rigidly connected to the vehicle and capable of being connected to an electronic control unit of the vehicle and at least one receiver intended to be rigidly connected to the removable battery and to be connected to at least one sensor capable of measuring a parameter of the removable battery, the transmitter and the receivers being capable of exchanging data via an inductive coupling.

The transmitter may include an antenna provided with at least one loop per receiver.

The inductive coupling between the transmitter and the receivers may operate in critical coupling.

The transmitter may include a power supply connected to an impedance transformer itself connected to the antenna.

The receiver may be connected to a control device connected to the sensors.

The control device may be connected to an intelligent integrated circuit connected at the output to the sensors.

The intelligent integrated circuit may include a microcontroller connected at the input to the control device and connected to a multiplexing device itself connected at the output to the sensors.

Other objects, characteristics and advantages will appear on reading the following description, given solely by way of non-restrictive example and referring to the attached drawings, in which:

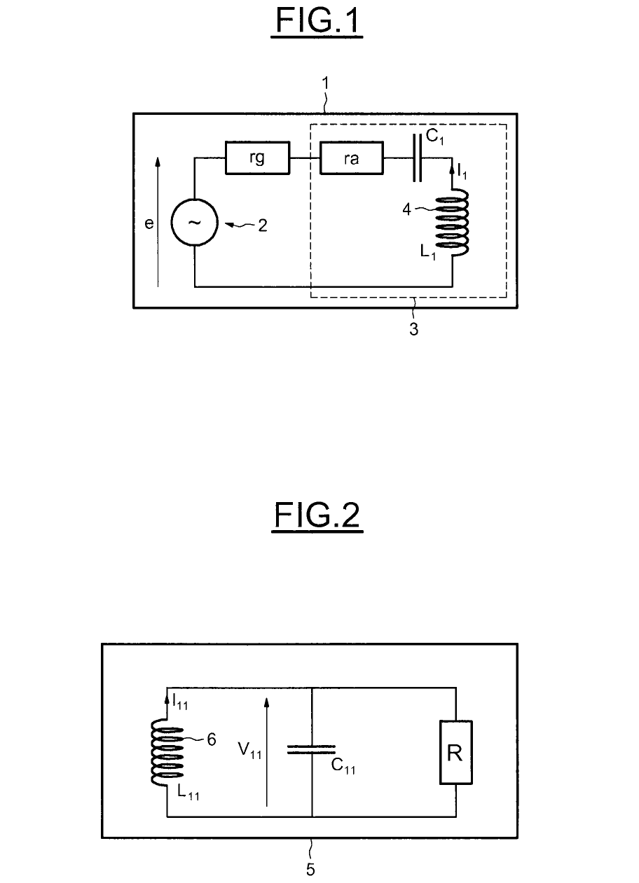

FIG. 1 illustrates an inductively coupled transmitter,

FIG. 2 illustrates an inductively coupled receiver,

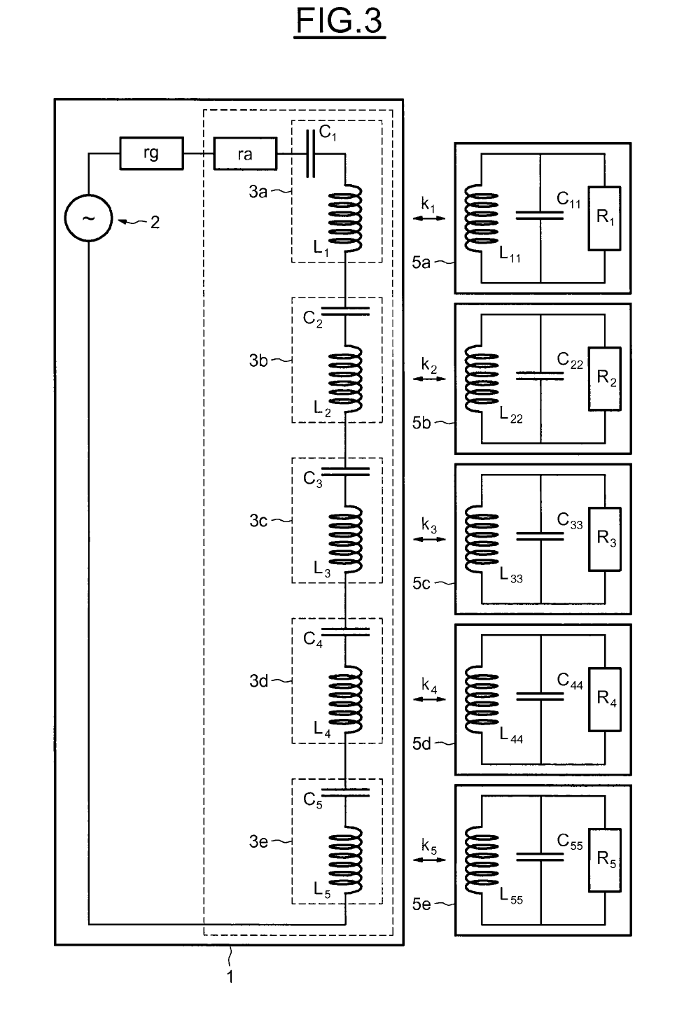

FIG. 3 illustrates a wireless communication system with a plurality of receivers,

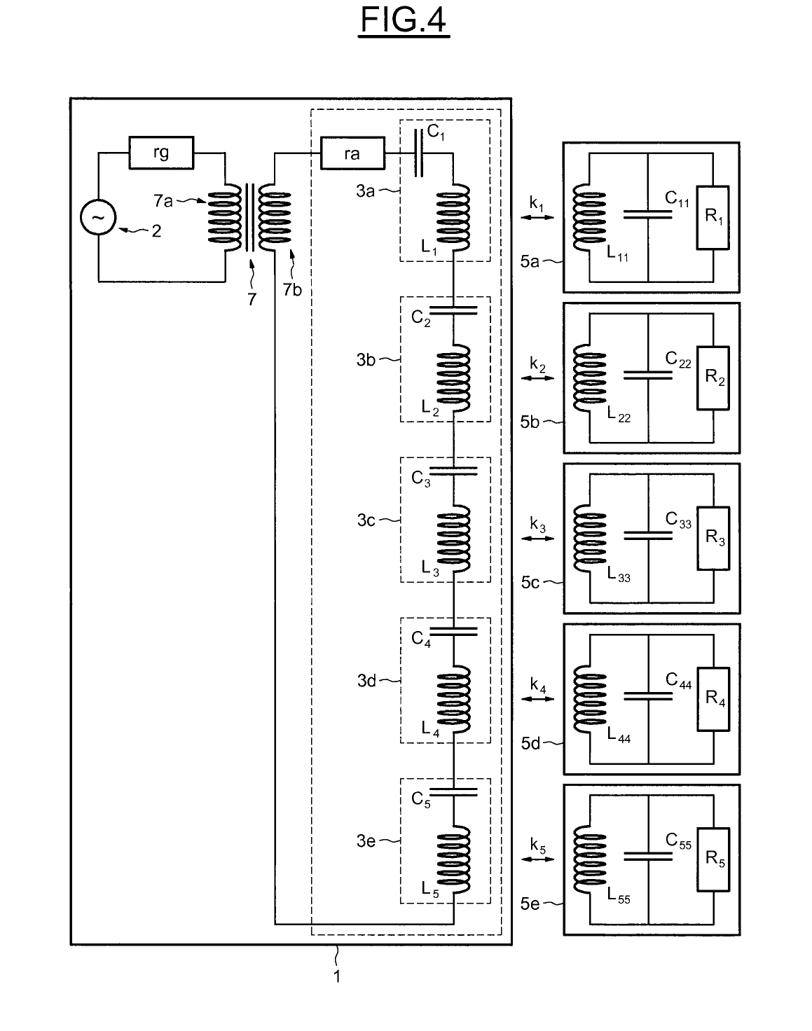

FIG. 4 illustrates a wireless communication system with a plurality of receivers and impedance matching, and,

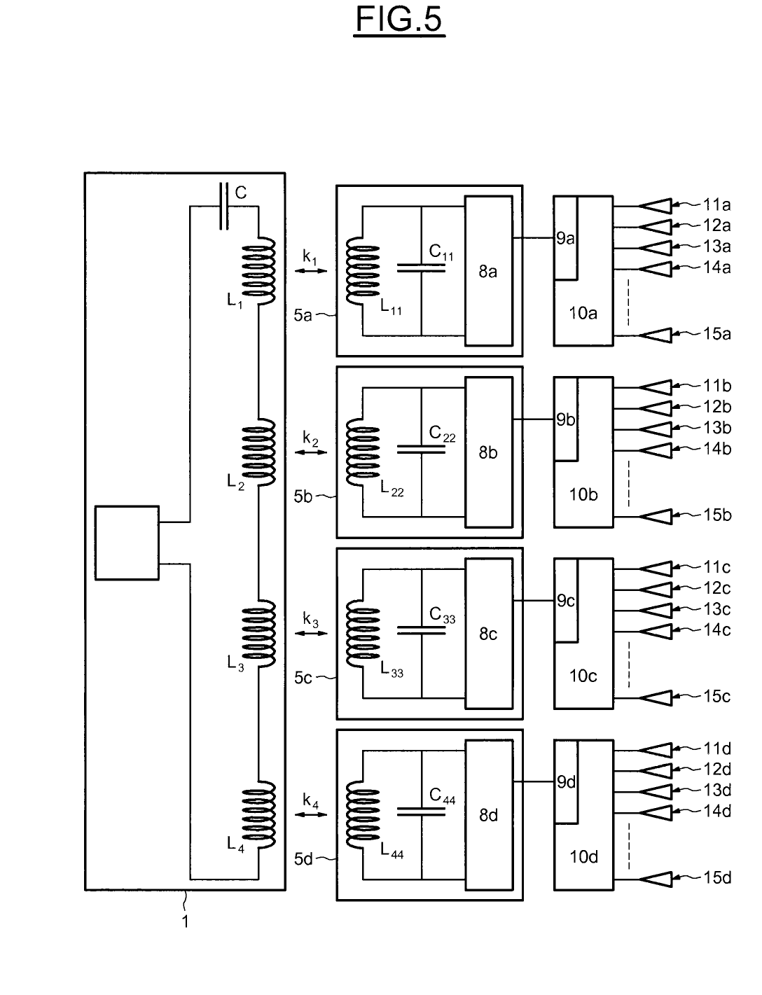

FIG. 5 illustrates a wireless communication system with a plurality of receivers provided with sensor multiplexing means.

Energy transfer devices, such as those used for contactless battery recharging, establish a link via radio frequency magnetic field between a transmitter and at least one receiver.

The coupling members used for establishing this link are conductive circuits such as loops, windings or coils known as antenna circuits or antenna coils. Electronic components are associated with these antenna circuits which are intended to perform frequency tuning, damping and impedance matching functions. The assembly then forms an antenna, in particular an inductive antenna.

FIG. 1 illustrates an inductive coupling transmitter of an inductive coupling system. The transmitter 1 includes a series resonant circuit including a resistance r, an inductance L₁ and a capacitance C₁. The series resonant circuit has a resonant frequency f₁ obtained via the following equations:

ω₁=2πf₁ (eq. 1)

L₁C₁ω₁²=1 (eq. 2)

The series resonant circuit is connected to a radio frequency generator modeled by the association in series of a voltage source 2 and an output resistance rg.

Furthermore, the antenna 3 is represented by a resistance ra associated with the capacitance C₁ and the inductance L₁.

All the elements being in series, the series resonant circuit has a resistance r equal to the sum of the resistances ra and rg.

The receiver 5 of the inductive coupling system illustrated in FIG. 2 includes a parallel resonant circuit, of resonant frequency f₂ obtained by the following equations:

ω₂=2πf₂ (eq. 3)

L₁₁C₁₁ω₂²=1 (eq. 4)

The coil 6 of the receiver is a simple inductance L₁₁. It may be connected to an electronic device that may include the capacitance C₁₁. This is particularly the case of RFID (Radio Frequency IDentification) systems. The coil of the receiver may also be connected to electronics with discrete components including the main functions of the receiver, such as energy management or energy storage.

The parallel resistance R₁ represents the resistance equivalent to the resistance of the coil and those of all the functions performed in the receiver.

The inductive link coupling between the transmitter 1 and the receiver 5 introduces a mutual inductance M, both on the side of the transmitter 1 and on the side of the receiver 5. This mutual inductance M is determined by applying the following equation:

M=k₁\sqrt{L₁L₁₁} (eq. 5)

with k₁ the coupling coefficient between the two antennas.

The coupling between the transmitter 1 and the receiver 5 may exhibit very different characteristics of energy transfer efficiency and sensitivity to positioning according to the design of the inductive coupling system. These characteristics determine three coupling regimes, conventional coupling, critical coupling and supercritical coupling.

In conventional coupling, the transmitter antenna is designed independently or quasi-independently of the receiver or receivers intended to be coupled. The capacitance C₁ is selected in order to satisfy the following equation:

L₁C₁ω₀²1 (eq. 6)

The value ra is the joining of losses specific to the antenna and an added resistance so as to set the quality coefficient and achieve impedance matching. We then have the following relationship:

ra=rg (eq. 7)

This matching may also be done through an impedance transformer or a capacitance bridge. When the transmitter is alone, half the energy is consumed in the output resistance rg and the other half in the resistance ra.

When one or more receivers are coupled with the transmitter, there is no longer any impedance matching between the generator and the transmitting antenna, as a result of introducing the term related to mutual inductance M:

Z=jMωI₁₁/I₁ (eq. 8)
With I₁: current flowing in the transmitter
I₁₁: current flowing in the receiver
ω: pulse

Devices using this coupling regime are designed so that this mismatch is low or moderate (raI₁>jM₁wI₁₁+jM₂wI₂₂+. . . ).

The mutual inductances introduced thus remain low or negligible. The main advantage offered by this regime is great flexibility of use and the main drawback is poor energy transfer performance between the transmitter and the receiver or receivers.

In the case of a critical coupling, the object is to optimize the energy transfer between a transmitter and a receiver. For this, the transmitters are designed for operating with receivers with known characteristics and positions.

The capacitance C₁ is still selected for satisfying equation 6. However, it must further fulfill the following conditions:

$$\{ \begin{matrix}ra {I}_{1} << jM {ωI}_{11} \\ jM ω {I}_{11} = rg {I}_{1}\end{matrix} \qquad ( eq . 9 )$$

These conditions can be rewritten to show the current ratio:

$$\{ \begin{matrix}ra << jM {ω}_{11} \text{/} {I}_{1} \\ jM ω {I}_{11} \text{/} {I}_{1} = rg\end{matrix} \qquad ( eq . 10 )$$

Alternatively, it is possible to fulfill the following condition in combination with the condition resulting from equation 6:

jMωI₁₁/I₁=(rg+ra) (eq. 11)

However, in this case, a portion of the energy is lost in the resistance ra. In the context of an optimized energy transfer, it is more useful to select a value of the resistance ra reduced to just the antenna losses and which is the lowest possible.

In other words, the object is to achieve impedance matching between the generator and the receiver to enable the generator to deliver maximum power in charging. This will effectively be the case only for a single relative position of the antennas. Thus a system is obtained with optimized energy transfer, but with limited flexibility of use.

In the case of a supercritical coupling, priority is given to energy transfer. The object is still to satisfy the first condition of equation 9. However, the second condition is now given by the following equation:

jMwI₁₁>rgI₁ (eq. 12)

Thus a better performance than the 50% limit of critical coupling can be had. However, for a given power generator, less energy will be transferred than in critical coupling.

This situation can be illustrated by the following example. It is possible to have a critical coupling system that expends a power of 1 W in the output impedance rg of the generator and 1 W in the receiver (the power relating to ra being negligible). In supercritical coupling, with the same system, it is possible to obtain a power of 0.5 W expended in rg and 0.8 W in the receiver. Supercritical coupling really does achieve a performance (62%) better than the 50% limit of critical coupling. However, less energy is transferred to the receiver.

In the example of battery recharging by wireless energy transfer, changing from critical coupling to supercritical coupling amounts to increasing performance while losing speed in recharging.

On the transmitter side, changing from critical coupling to supercritical coupling while keeping the same energy transfer amounts to having a generator with a weaker source impedance. This often amounts to having a more powerful generator that is more failure-resistant. In this coupling regime, the generator may become overheated and be rendered unusable if it is not suitably dimensioned.

Data transfer via inductive coupling in a communication system is based on physical principles similar to those relating to energy transfer. Indeed, data transfer generally corresponds to an amplitude and/or temporal modulation of a given energy carrier wave. Thus the transferred energy is modulated. Since the communication system is intended to be onboard a motor vehicle, it is designed for promoting the autonomy of the vehicle and therefore energy efficiency. Critical coupling is therefore preferred to conventional or supercritical couplings.

The structure of the transmitter and receivers of the communication system will be described below in relation to FIGS. 3 to 5.

The communication system transmitter applies the teachings described above.

The transmitter antenna includes at least as many loops as receivers. According to the technical characteristics of the induction field to be generated, one or more windings will be used for forming each loop. Furthermore, the dimensions of these loops are matched to the dimensions of the receivers in order that the radiation of the loops is restricted as far as possible to the surface of the receivers. This thus limits the radiated power to the amount necessary for interaction with the receivers.

The tuning capacitance may be estimated by calculating the inductance of the antenna, which depends on the geometry and the number of windings. In order to avoid undesirable parasitic capacitance phenomena, the tuning capacitance is distributed over the whole antenna, given that the loops are in series. The capacitance is determined at the resonance frequency, e.g. 13.56 MHz.

The resistance ra is reduced to the inherent resistance of the conductive wire. When considering power transfer, this involves a minimum of energy dissipation on passive components. Furthermore, this resistance can be used to cancel out the quality factor of the transmitting antenna.

A transmitter including such an antenna is illustrated in FIG. 3. A contactless communication system can be seen in this figure in which five receivers are associated with one transmitter.

The contactless communication system includes a transmitter 1 and five receivers (5a, 5b, 5c, 5d, 5e) based on the coupling principles of inductive systems described above in relation to FIGS. 1 and 2.

The transmitter 1 includes a voltage source 2, an output resistance rg, a resistance ra, and five antennas (3a, 3b, 3c, 3d, 3e), the assembly being connected in series. Each antenna (3a, 3b, 3c, 3d, 3e) includes a capacitance (C₁, C₂, C₃, C₄, C₅) connected in series with an inductance (L₁, L₂, L₃, L₄, L₅).

Each receiver (5a, 5b, 5c, 5d, 5e) includes an inductance (L₁₁, L₂₂, L₃₃, L₄₄, L₅₅) connected in parallel with a capacitance (C₁₁, C₂₂, C₃₃, C₄₄, C₅₅) and a resistance (R₁, R₂, R₃, R₄, R₅).

Each receiver (5a, 5b, 5c, 5d, 5e) is inductively coupled with one antenna (3a, 3b, 3c, 3d, 3e) of the transmitter 1, each inductive coupling being characterized by a coefficient (k₁, k₂, k₃, k₄, k₅) for determining the mutual inductance M by applying equation 5.

FIG. 4 illustrates a contactless communication system in which the transmitter includes an impedance transformer 7 and is associated in series with five receivers.

FIG. 4 shows the main elements of FIG. 3 which assume the same roles. FIG. 4 differs from FIG. 3 by the presence of the impedance transformer 7, whereof the primary winding 7a is connected to the resistance rg and to the voltage generator 2. The secondary winding 7b is in turn connected to the resistance ra and to the impedance L₅.

The impedance transformer 7 matches the antenna impedance to the generator. The transformer ratio between the primary winding 7a and the secondary winding 7b is given by the following equation:

$$\frac{{Z}_{1}}{{Z}_{2}} = {( \frac{{N}_{1}}{{N}_{2}} )}^{2} \qquad ( eq . 13 )$$

This matching is done so as to obtain an output impedance from the transmitter comparable to the impedance of the receiver taking into account the influence of the metal environment. In addition, given that the presence of the battery and the impedance transformer adds an additional inductance, it is necessary to compensate for the presence thereof by modifying the capacitance value. It is thus possible to obtain a desired value of impedance seen by the transmitter antenna, e.g. 50Ω.

The system illustrated in FIG. 4 thus offers a wider choice of impedance values. This has the advantage of greater freedom in the design and dimensioning of coils, antennas and transmission electronics. It is thus possible to use a conventional generator having an output impedance of 50Ω. In return, an additional component is needed.

FIG. 5 illustrates a communication system between one transmitter and a plurality of receivers illustrating the integration of the receivers with data acquisition systems including sensors, in particular multiplexed sensors.

A communication system may be integrated into a data acquisition system and include a receiver (5a, 5b, 5c, 5d) provided with a control device (8a, 8b, 8c, 8d), an intelligent integrated circuit (9a, 9b, 9c, 9d), a multiplexing system of sensors (10a, 10b, 10c, 10d) and sensors 11a to 15d. The sensors may in particular be temperature, voltage, pressure or current sensors. When the receiver is coupled (5a, 5b, 5c, 5d), the transmitter 1 sends a command which will be translated by the control device (8a, 8b, 8c, 8d) into control instructions intended for the intelligent integrated circuit (9a, 9b, 9c, 9d) which controls the multiplexing system (10a, 10b, 10c, 10d). In return, the intelligent integrated circuit (9a, 9b, 9c, 9d) transmits the required value or values measured by the sensors to the control device (8a, 8b, 8c, 8d). The exchanges of instructions and measured values may be achieved via a serial bus, in particular an SPI™ bus. The data are then transmitted via RFID link to the transmitter 1.

The intelligent integrated circuit (9a, 9b, 9c, 9d, 10a, 10b, 10c, 10d) may include a microcontroller (9a, 9b, 9c, 9d) connected at the input to the control device (8a, 8b, 8c, 8d) and connected to a multiplexing device (10a, 10b, 10c, 10d) itself connected at the output to the sensors. It is also possible for the intelligent integrated circuit (9a, 9b, 9c, 9d) to support the functions of the multiplexing system (10a, 10b, 10c, 10d). It is also possible to set up a controlled analog-to-digital converter enabling the control device (8a, 8b, 8c, 8d) to transmit more precise commands for selecting the sensor for which the measurement is transmitted, or specifying the transmission of sensor measurements in a certain order.

Although not shown in the figures described above, the positions of the transmitting antenna and those of the receivers play a very important role in optimizing power transfer, and in obtaining a critical coupling. The whole system must therefore be positioned as accurately as possible in the space. Indeed, a horizontal or vertical offset can lead to a loss of coupling efficiency, while too small a distance between transmitter and receiver can lead to an unwanted supercritical coupling.

For obtaining an accurate placement, it is possible to use structures with a quick attachment system, for accurately positioning the transmitter with respect to the receiver while retaining the possibility of removing the battery with the sensors which are connected thereto.

The receiver antenna and the sensors may be made of a flexible material such as Kapton™ in order to be able to reach all the possible locations of the battery surface and in order to be able to reduce the weight of the assembly.

Alternatively, it is possible to provide an additional resistance in order to pass from a supercritical coupling to a critical coupling, in particular when it is not possible to vary the distance between the transmitter and the receiver. Indeed, the critical coupling coefficient depends on the quality factor of the transmitter and receiver and may be reduced by adding a resistance in series on the transmitter side and/or in parallel on the receiver side.

On the other hand, if the addition is made on the transmitter side, the resistance will be a source of energy dissipation. If the addition is made on the receiver side, the quality factor will diminish.

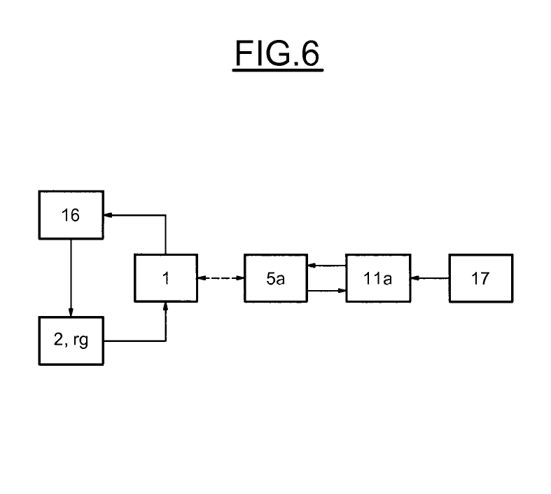

FIG. 6 illustrates an overview of the wireless communication system. The transmitter 1 can be seen connected to the power supply 2, rg controlled by an electronic control unit 16. The transmitter 1 is also connected at the output to the electronic control unit in order to be able to transmit thereto the information received.

It can also be seen that a receiver 5a is connected to a sensor 11a arranged on the removable battery 17. The sensor 11a is activated by the reception of a signal from the receiver 5a and transmits in return the information of the measurements made on the removable battery 17. The measurement information is then transmitted to the transmitter 1 via the inductive coupling between transmitter and receiver. The transmitter 1 then transmits it to the electronic control unit 16.

The wireless communication system is thus optimized with regard to energy consumption between one transmitter and a plurality of receivers in the presence of a metal object, in particular a motor vehicle. This system makes it possible to reduce the quantity of direct connections on a battery pack.

One of the applications of this system is the measurement of temperature at a plurality of points on the battery in order to create a three-dimensional thermal map. This can be used to discover the state of each battery cell, in order to optimize the charging thereof and reduce the risk of damage or explosion.

1-7. (canceled)

8. A wireless communication system for a motor vehicle including a removable battery, the system comprising:
a transmitter configured to be rigidly connected to the vehicle and configured to be connected to an electronic control unit of the vehicle; and
at least one receiver configured to be rigidly connected to the removable battery and to be connected to at least one sensor configured to measure a parameter of the removable battery;
the transmitter and the at least one receiver configured to exchange data via an inductive coupling.

9. The system as claimed in claim 8, wherein the transmitter includes an antenna including at least one loop per receiver.

10. The system as claimed in claim 8, wherein the inductive coupling between the transmitter and the receivers operates in critical coupling.

11. The system as claimed in claim 8, wherein the transmitter includes a power supply connected to an impedance transformer itself connected to the antenna.

12. The system as claimed in claim 8, wherein the receiver is connected to a control device connected to the sensors.

13. The system as claimed in claim 12, wherein the control device is connected to an intelligent integrated circuit connected at the output to the sensors.

14. The system as claimed in claim 13, wherein the intelligent integrated circuit includes a microcontroller connected at an input to the control device and connected to a multiplexing device itself connected at an output to the sensors.
